(19) United States
(12) Patent Application Publication
(10) Pub. No.: US 2001/0029694 A1
(43) Pub. Date: Oct. 18, 2001

(54) Fish trap habitat system

(76) Inventor: Henry Bodden, Woodland Hills, CA (US)

Correspondence Address: Scott W. Kelley, KELLY BAUERSFELD LOWRY & KELLEY, LLP, Suite 1650, 6320 Canoga Avenue, Woodland Hills, CA, 91367, US

(21) Appl. No.: 09/739,050

(22) Filed: Dec. 15, 2000

Related U.S. Application Data
(60) Provisional application No. 60/170,886, filed on Dec. 15, 1999.

(51) Int. Cl. A01K 71/00

(52) U.S. Cl. 43/102

(57) ABSTRACT

A fish trap habitat system including fish trap habitats which are movable to varying ocean depths and ocean floor locations. The fish trap habitats include a frame of interconnected hollow frame members, and a screen attached to the frame to form a fish trap enclosure. Portals are formed through the fish trap enclosure. The fish trap habitat can include an artificial reef within the fish trap enclosure. The frame can include a pontoon, a removable holding tank, and accept wheels for travel on dry land. In one form, the fish trap habitat is raised and lowered by a hollow cable fluidly connected to the frame and capable of injecting air into the hollow frame members. In another form, a propulsion system is attached to the frame of the first fish trap habitat. In yet another form, the fish trap habitat includes a structural framework forming a multi-level structure.

### RELATED APPLICATION

This application claims priority from Provisional Application Ser. No. 60/170,886, filed Dec. 15, 1999.

### BACKGROUND OF THE INVENTION

The present invention relates to fishing practices in general. More particularly, the invention relates to a fishing practice utilizing mobile fish trap habitats.

Presently employed fishing practices entail the unnecessary and indiscriminate slaughter of marine life. A commonly used fishing practice involves trailing long leaders behind a boat having hundreds or even thousands of baited hooks. Another commonly employed practice involves deploying large nets over a wide area of ocean to capture large schools of fish.

However, these methods capture and kill many fish and marine life which are either undesirable or unmarketable. In some countries, such as members of the EEC, only one type of fish is allowed for any fishing vessel. The indiscriminate fishing practices currently used result in the throwing overboard of thousands of tons of dead fish every year. This needless waste of fish is a growing concern due to over fishing and ever increasing depleted supplies of fish.

Even after the desired fish are caught and selected, the fisherman ends up with perishable product which must either be dried, frozen or sold within a relatively short time frame. As fresh fish is most desired by the consumer, the fisherman is placed in a position of having to catch, select, and deliver fish in a very short time period, sometimes within the same day. If the fish is not fresh, the fisherman stands to lose a considerable amount of money.

Accordingly, there is a need for a fishing practice which eliminates the indiscriminate slaughter of part of the fish catch. What is also needed is a fishing practice which allows the segregation of fish which can be immediately sold for profit, raised to a larger size, held for larger quantities, or released into the ocean. What is further needed is a fishing practice which enables the fishing entity to maintain the catch alive and in a natural environment until sold to aid the fisherman in delivering fresh fish. The present invention fulfills these needs and provides other related advantages.

### SUMMARY OF THE INVENTION

The present invention resides is a fish trap habitat system in which fish trap habitats can be selectively placed at varying ocean depths and locations on the ocean floor. The system includes the use of fish trap habitats which comprise a three-dimensional frame of interconnected hollow frame members, and a screen attached to the frame to form a fish trap enclosure. Portals are formed through fish trap enclosure and configured to allow fish and sea creatures of a predetermined size to enter into the fish trap enclosure from outside of the fish trap habitat while prohibiting fish and sea creatures of predetermined size from exiting the fish trap habitat.

Typically, the frame includes a base fluidly connected to hollow members extending upwardly from the base. The frame can include a pontoon, and a removable holding tank. Preferably, the frame is configured to accept wheels for travel on dry land.

The portals comprise conical passageways extending into the fish trap enclosure. An artificial reef may be placed within the fish trap enclosure. A gate can be formed in the screen of sufficient size to allow a human diver to enter into the fish trap enclosure.

Means are provided for raising and lowering the fish trap enclosure. In one embodiment, the means for raising and lowering comprises a hollow cable fluidly connected to the frame and capable of injecting pressurized air into the hollow members and the base. In another embodiment, the means for raising and lowering comprises a propulsion system attached to the frame of the fish trap habitat. The propulsion system includes a propeller and rudder and a receiver for receiving propulsion instructions from a remotely controlled transmitter.

In yet another embodiment, the fish trap enclosure includes a structural framework forming a multi-level structure. The structural framework includes doors formed in the structural framework to allow entry of human divers into the multi-level structure. The structural framework includes passageways between the multiple levels, and fish trap enclosures for fish and sea creatures. Preferably, the structural framework is at least partially surrounded by an artificial reef. A gate is formed in the screen of the fish trap habitat to allow a human diver to enter into the fish trap enclosure.

Other features and advantages of the present invention will become apparent from the following more detailed description, taken in conjunction with the accompanying drawings which illustrate, by way of example, the principles of the invention.

### BRIEF DESCRIPTION OF THE DRAWINGS

The accompanying drawings illustrate the invention. In such drawings:

FIG. 1 illustrates a representative vessel towing and positioning fish trap habitats embodying the present invention;

FIG. 2 is a perspective view of a fish trap habitat of FIG. 1;

FIG. 3 is an end view of the fish trap habitat of FIGS. 1 and 2;

FIG. 4 is a top plan view of the fish trap habitat of FIGS. 1-3;

FIG. 5 is a perspective view of a fish trap habitat similar to FIGS. 1-4 without an overlying screen;

FIG. 6 is a cross-sectional view taken generally along line 6-6 of FIG. 5 and representing forced air flow through the structure thereof;

FIG. 7 is a bottom plan view taken generally along lines 7-7 of FIG. 5;

FIG. 8 is a partially exploded perspective view of a fish trap habitat similar to FIG. 2, illustrating the use of wheels for transportation, a removable holding tank, and a propulsion system;

FIG. 9 is a perspective view of another fish trap habitat embodying the present invention;

FIG. 10 is a bottom plan view generally taken along line 1010 of FIG. 9;

FIG. 11 is a perspective view of yet another fish trap habitat having a multi-level structure built therein; and

FIG. 12 is a partially fragmented and cross-sectional view of FIG. 11, illustrating doors and passageways formed in the multi-level structure.

### DETAILED DESCRIPTION OF THE PREFERRED EMBODIMENTS

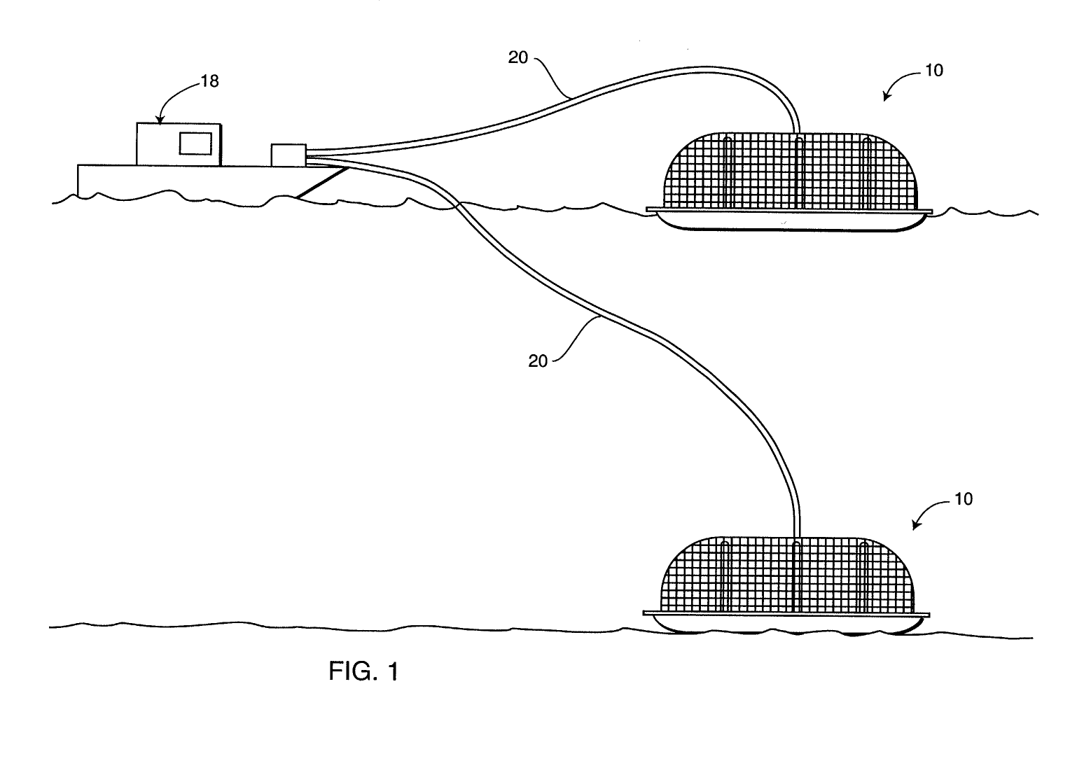

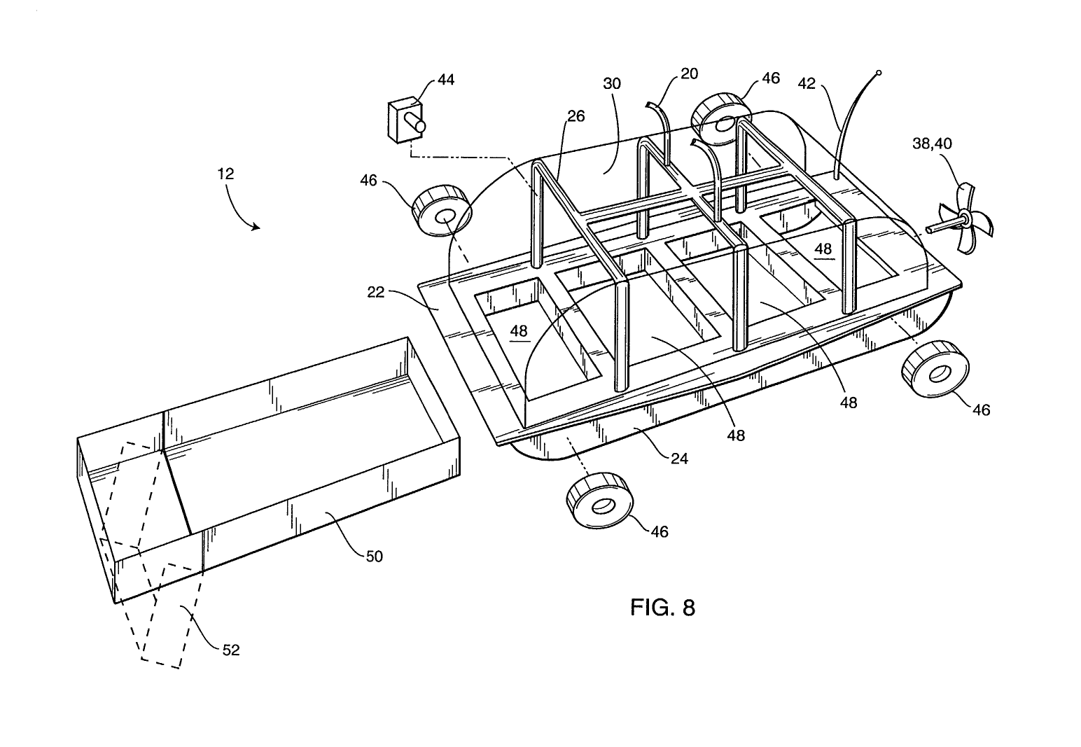

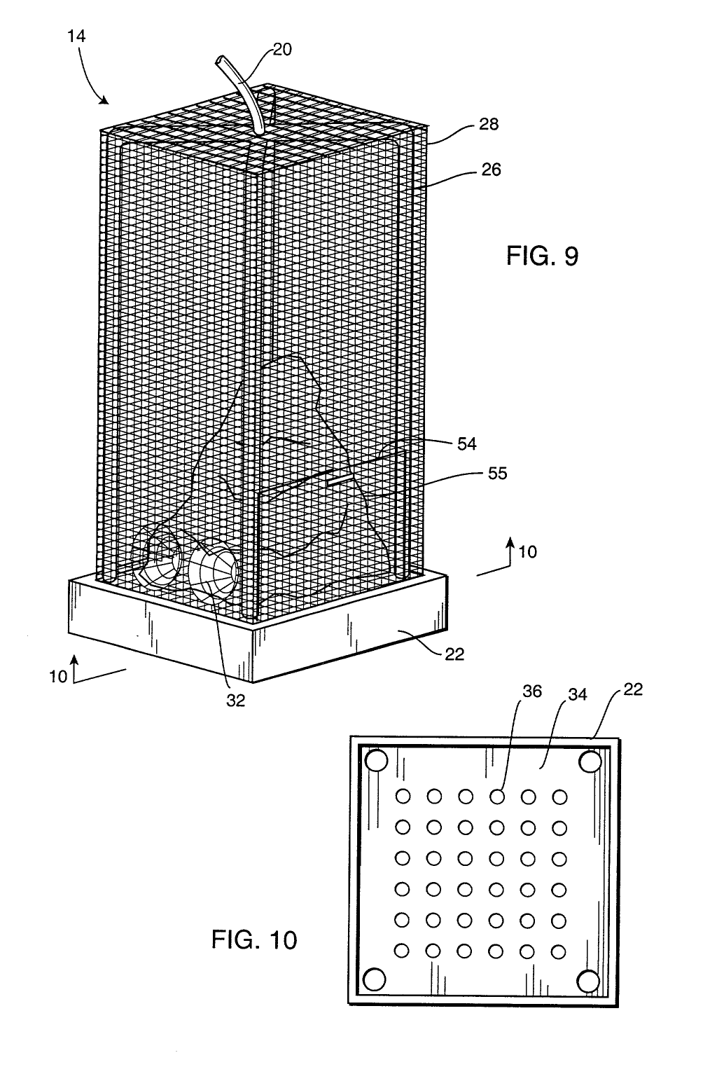

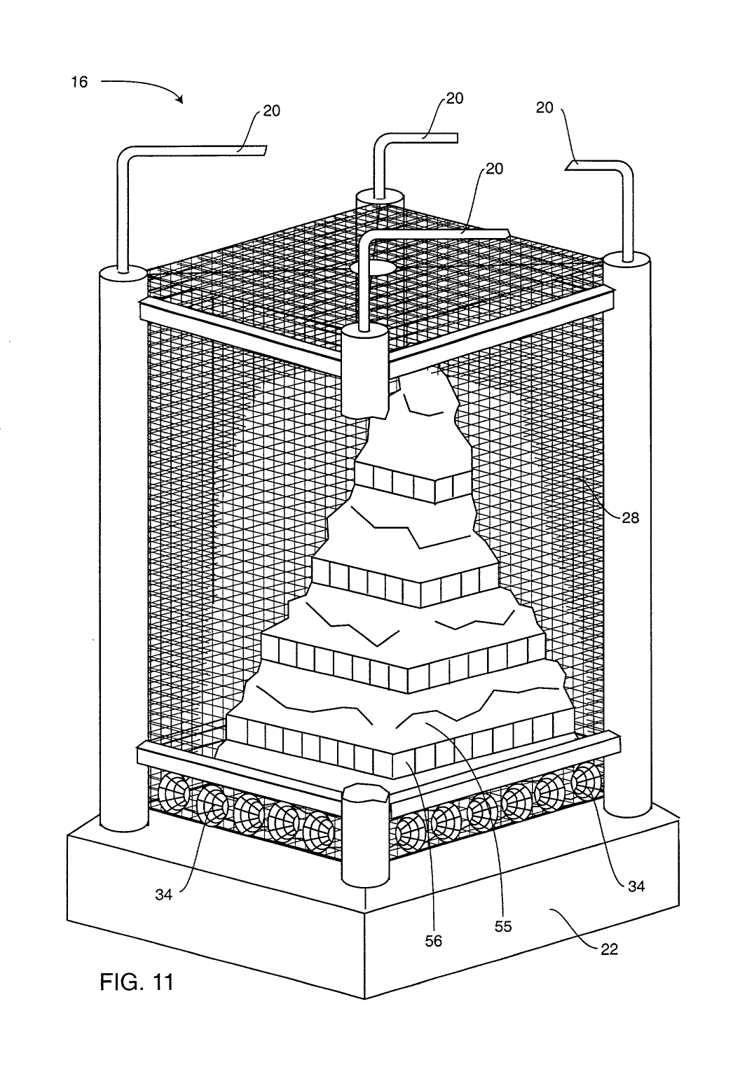

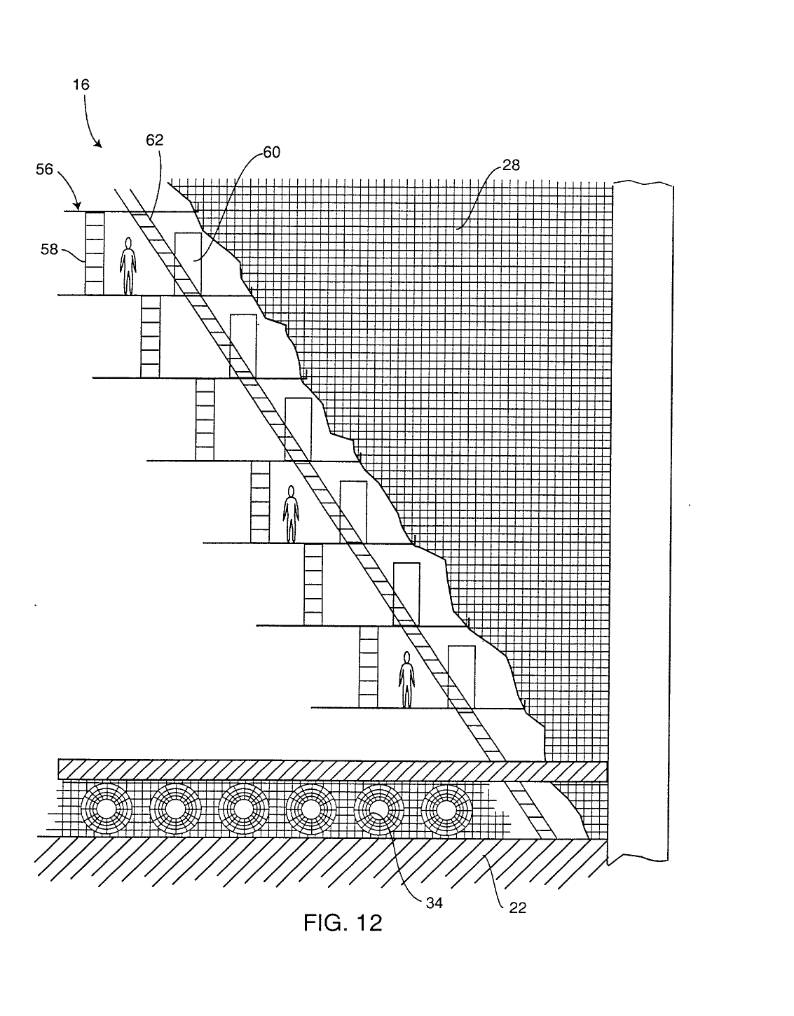

As shown in the drawings for purposes of illustration, the present invention is concerned with a fish trap habitat system including one or more fish trap habitats, referred to in FIGS. 1-7 by the reference number 10, in FIG. 8 by the reference number 12, in FIGS. 9 and 10 by the reference number 14, and in FIGS. 11 and 12 by the reference number 16. The fish trap habitats 10-16 are movable to varying ocean depths or ocean floor locations.

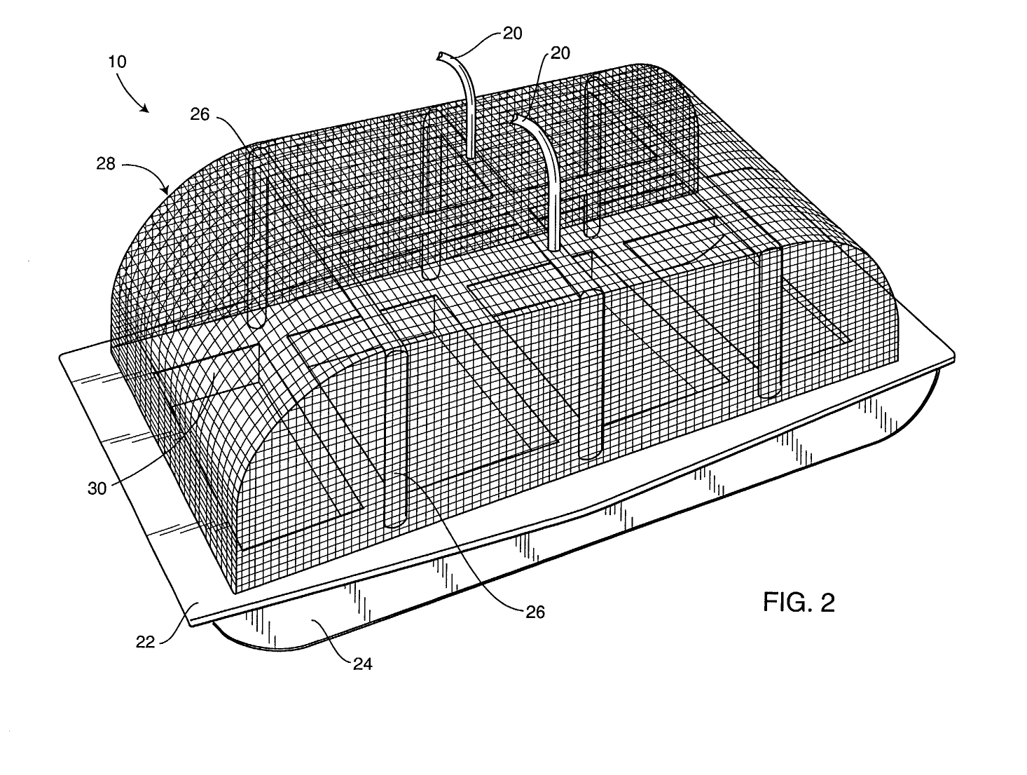

A first preferred embodiment of the system is illustrated in FIG. 1, wherein the fish trap habitats 10 are connected to a vessel 18, such as a fishing boat, by cables 20 which preferably comprise hollow air tubes. As more clearly illustrated in FIG. 2, the fish trap habitat 10 includes a catamaran-like base supported by two pontoons 24. Hollow tubular frame members 26 extend upwardly from the base 22 to form a three-dimensional frame. A screen 28 overlies and covers the frame members 26 and base 22 to form a fish trap enclosure 30 therein. The screen 28 can be comprised of nylon, metal or any other suitable material having sufficient strength and durability to resist corrosion and restrict the travel of fish from entering or exiting the fish trap enclosure.

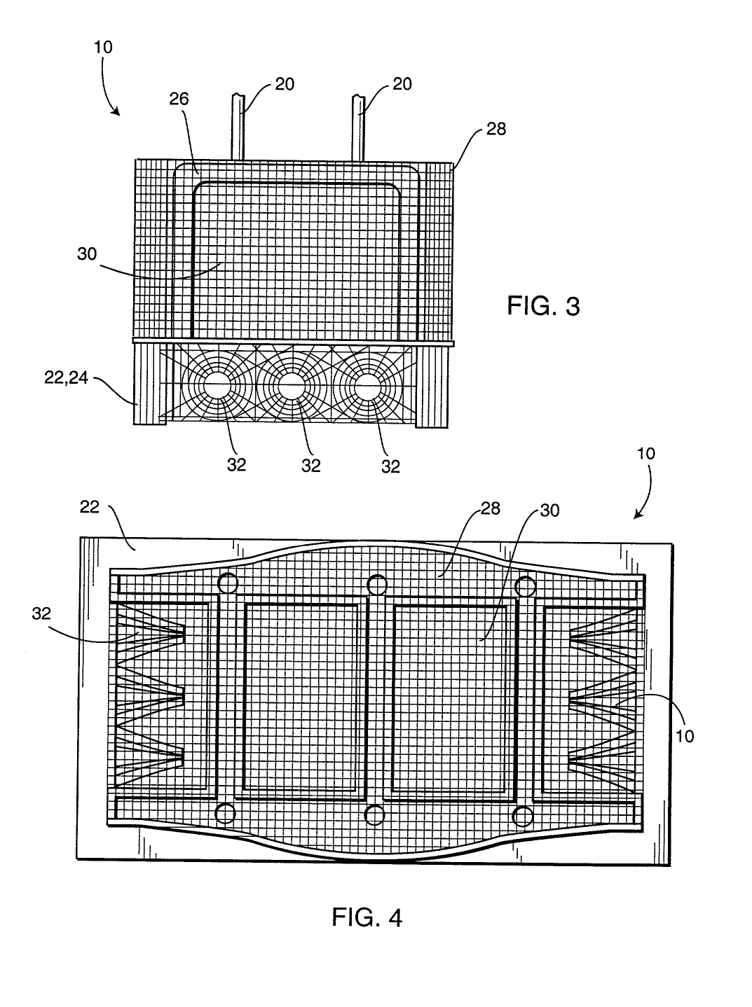

As illustrated in FIGS. 2-4, the fish trap habitat 10 is designed to allow fish and other sea creatures in without the possibility of getting out. This can be accomplished by altering the screen size so that sea creatures of a predetermined size can be secured within the fish trap habitat 10, or prevented from entering therein. Preferably, portals, such as the conical passageways 32 illustrated in FIGS. 3 and 4, are formed within either the screen covering 28 or the base 22. The conical passageways 32 are configured such that fish of predetermined size may enter into the fish trap habitat 10, while preventing larger and perhaps predatory fish and other creatures from entering.

Smaller fish and creatures which are harmless and may act as a food source for the desired catch may enter and exit freely. The desired fish may be introduced into the fish trap habitat 10 using a variety of methods including the introduction of chum into the fish trap habitat 10 or placing the desired fish into the fish trap habitat 10 and allowing the fish to grow to a predetermined size before harvesting.

By adjusting the screen size and entry port passageways 32, a selected specie or number of species are sheltered and protected while keeping other creatures without the fish trap habitat 10. For example, the area designated for a lobster needs to be designed to exclude a trigger fish because the trigger fish will eat the lobster. Similarly, the area designed to invite a grouper or a snapper needs to be designed to exclude a shark.

The fish trap habitats 10 can include artificial reefs, as illustrated in FIG. 9, that can be designed to mimic the natural environment including trees, vegetation and rocks to provide shelter and to promote the growth of microorganisms to feed young hatchlings. When a creature or fish with eggs is trapped, the creature can be removed and placed in a more secure environment for the preservation and growth of the young hatchlings. The food for young hatchlings, algae and plankton that grow naturally within the habitats, assist the fisherman in maintaining well fed creatures.

Referring back to FIG. 1, the fish trap habitats 10 can be towed behind a vessel 18 and placed on the ocean floor or floated at whatever depth necessary to harvest or grow a variety of different sea creatures. The forms of towing and retrieving the fish trap habitats 10 include in the most simplest form cables 20 interconnected between the fish trap habitats 10 and a winch or the like on the fishing vessel 18.

A particularly preferred form of raising and moving the fish trap habitats 10 includes the use of a hollow air tube as the cable 20 which is interconnected between an air source on the vessel 18 and the hollow tubular frame members 26, which in turn are fluidly connected to the base 22. As the fish trap habitat 10 is lowered into the ocean, air is released from the base 22 and frame members 26 as water fills these structures, causing the fish trap habitat 10 to sink. Gate valves or the like (not illustrated) can be incorporated into the base 22 and frame members 26 to control the amount of water allowed into these structures, thus limiting the amount of displaced air and allowing the fishing entity to control the depth at which the fish trap habitat 10 resides.

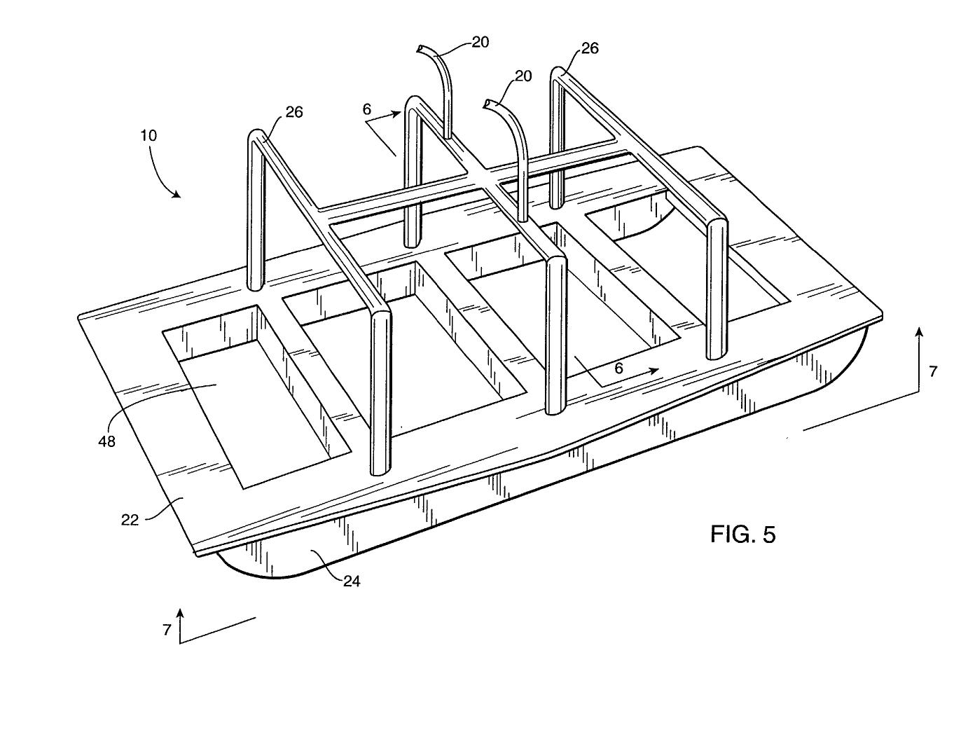

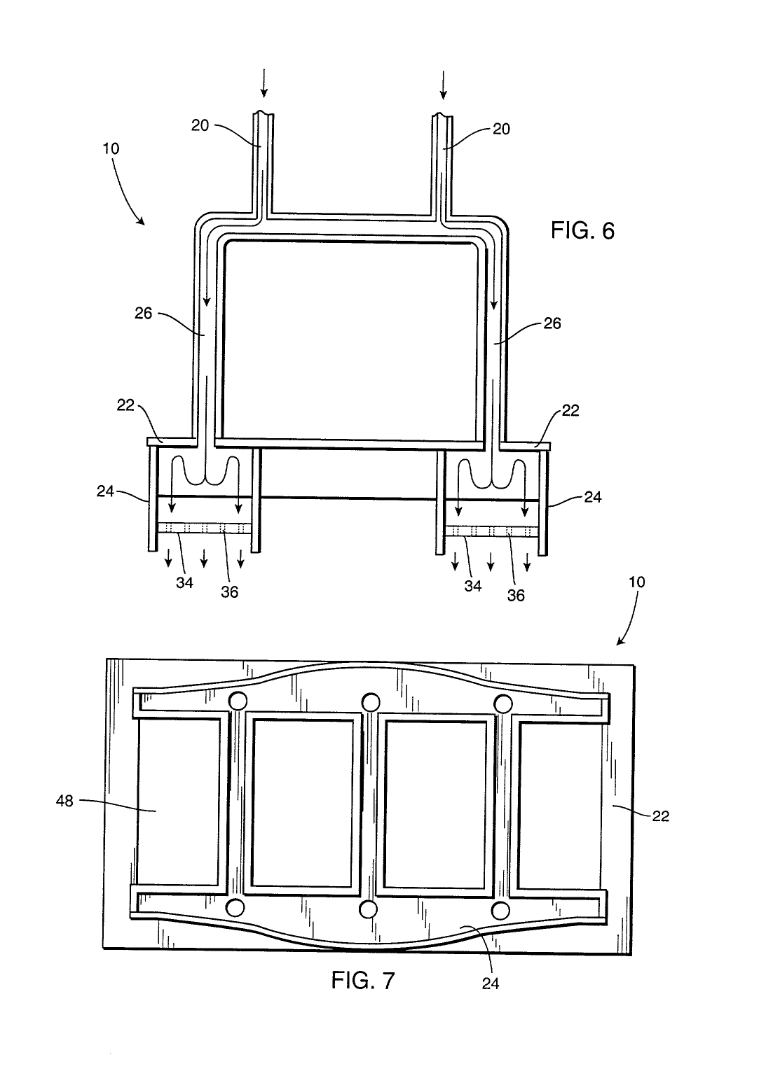

To raise the fish trap habitats 10 pressurized air is injected through the hollow cable 20 forcing the water out of the frame members 26 and base 22 until the fish trap habitat 10 acquires the necessary buoyancy to raise it out of the water. This technique is commonly referred to as jetting. Although as few as one hollow cable 20 can be used, preferably two or more hollow cables 20 are strategically placed in the frame members 26, as illustrated in FIGS. 5 and 6, to provide a more even flow of air. An air manifold having adjustable valves (not shown) can be used by an operator on the vessel 18, dock or the like to control the amount of air injected into each hollow cable 20. This enables the operator to adjust the air flow as necessary to raise the fish trap habitat 10 in a level and stabilized manner. Referring to FIG. 6, baffles 34 are preferably incorporated into the base 22 or pontoon structures 24 in order to more evenly distribute the jetting of the injected air through the base 22. Such baffles 34 can comprise multiple apertures 36 formed in the base 22 or pontoon structure 24, or any other form of baffle as is known in the art.

With reference to FIG. 8, an automated and self-propelled fish trap habitat 12 is illustrated. The fish trap habitat 12 includes a propulsion system comprising a propeller 38, a rudder 40 and a receiver/control mechanism 42 which actuates the propeller 38 and rudder 40 in accordance with propulsion instructions received from a remotely controlled transmitter (not shown). A television camera 44 can also be attached to the fish trap habitat 12 to allow remote monitoring of the process, as necessary. The fish trap habitat 12 can also include a buoyancy system, such as pressurized air tanks or the like, to enable the fish trap habitat 12 to rise from the ocean surface. The fish trap habitats 12 can be programmed or controlled remotely to proceed to a given location, submerged to a give depth, open points of entry for fish and sea creatures, discharged chum to attract fish and sea creatures, close the portals 32 and raise to the surface or proceed to a designated location to offload its catch. Such a location can include a fishing vessel 18, boat dock, pier, beach, or any other convenient location.

As illustrated in FIG. 8, the fish trap habitats 12-16 can be configured to accept wheels 46 which facilitate transportation of the fish trap habitats 12-16 on dry land. The base 22 can be configured to include bins 48 or other openings which provide access to a holding tank 50 removably positioned within the base 22. Upon rising to the surface, or being removed from the water, the fish catch and water flow into the holding tank 50 in order to congregate the fish and sea creatures therein and keep them alive. The holding tank 50 may be later removed from the base 22 to facilitate the removal of the catch. The holding tank 50 may also include a pivoting section 52 in order to more easily remove the catch out of the holding tank 50.

The size, configuration, and design of the fish trap habitats 10-16 can be altered to meet the available needs, as reflected in the fish trap habitat 14 illustrated in FIGS. 9 and 10. Such fish trap habitats 16 include the base 22, hollow frame members 26, overlying screen 28 form a fish trap enclosure 30 and a means for raising and lowering the fish trap habitat 16. The fish trap habitat 14 can also include the conical passage portals 32 and/or a gate 54 which can be selectively opened or closed to allow a human diver to place items within the fish trap enclosure 30 or remove them therefrom. The gate 54 can be sized according to the needs of the fishing entity. In some cases, it is contemplated that the gate 54 be large enough to permit a human diver to enter into the fish trap enclosure 30. As illustrated in FIGS. 9 and 10, the fish trap habitat 14 includes a hollow cable 20 for injecting pressurized air into the frame members 26 and base 22 for raising and lowering the fish trap habitat 14.

Referring now to FIGS. 11 and 12, yet another embodiment of the fish trap habitat 16 is illustrated. The fish trap habitat 16, while similar to the above-described embodiments, is of a very large size so as to accommodate a structural framework forming a multi-level structure 56 within the fish trap enclosure 30. Each level of the multi-level structure 56 is sized to permit the storage of multiple fish trap enclosures 58 which hold fish and sea creatures independent of one another. The levels of the multi-level structure 56 are also sized such that a human diver can enter into the multi-level structure and access the fish trap enclosures 58. Preferably, the multi-level structure 56 includes doors 60 or the like for entering into the levels of the multi-level structure 56 so as to restrict access thereto. Passageways 62 are formed between the various levels of the multi-level structure 56 to permit the divers to travel from level to level, using ladders or the like. Preferably, the multi-level structure 56 is at least partially surrounded by an artificial reef 64 designed to mimic the natural environment including trees, vegetation and rocks to provide shelter and to promote growth of microorganisms and other fish to feed young hatchlings or the sea creatures in question. It is contemplated that such fish trap enclosures 58 can be designed to house sea creatures laden with eggs, the eggs of the sea creatures themselves, or used to separate sea creatures which might otherwise harm one another.

Although the fish trap habitat 16 may be of such a size to form a permanent structure on the ocean floor, it is contemplated that such a fish trap habitat 16 be capable of being raised to the ocean surface. This could be by a variety of means, including the hollow tube cable 20 pressurized air jetting system described above. Alternatively, the multi-level structure 56 can be positioned on an elevator-like mechanism capable of raising and lowering the multi-level structure 56.

It is to be understood from the foregoing that the fish trap habitat systems described above provide a fishing practice which selectively captures fish which can be segregated and raised to a larger size or held for larger quantities, or at least into the ocean to eliminate the indiscriminate slaughter of sea creatures. The fish trap habitat system of the present invention also enables a fishing entity to maintain the catch alive and in a natural environment until sold. The invention also allows the fish trap habitats 10-16 to be selectively placed at varying ocean depths and location on the ocean floor to accommodate the fish or sea creatures which are being harvested.

Although several embodiments have been described in detail for purposes of illustration, various modifications may be made without departing from the scope and spirit of the invention. Accordingly, the invention is not to be limited, except as by the appended claims.

What is claimed is:

1. A fish trap habitat, comprising:
a three-dimensional frame of interconnected hollow frame members;
a screen attached to the frame to form a fish trap enclosure;
portals formed through the fish trap enclosure and configured to allow fish and sea creatures of a predetermined size to enter into the fish trap enclosure from outside of the fish trap habitat while prohibiting fish and sea creatures of a predetermined size from exiting the fish trap habitat; and
means for raising and lowering the fish trap enclosure.

2. The fish trap habitat of claim 1, wherein the frame includes a base fluidly connected to hollow members extending upwardly from the base.

3. The fish trap habitat of claim 2, wherein the means for raising and lowering comprises a hollow cable fluidly connected to the frame and capable of injecting pressurized air into the hollow members and the base.

4. The fish trap habitat of claim 1, wherein the means for raising and lowering comprises a propulsion system attached to the frame of the fish trap habitat.

5. The fish trap habitat of claim 4, wherein the propulsion system includes a propeller and a rudder and a receiver for receiving propulsion instructions from a remotely controlled transmitter.

6. The fish trap habitat of claim 1, wherein the frame includes a pontoon.

7. The fish trap habitat of claim 1, wherein the frame is configured to accept wheels for travel on dry land.

8. The fish trap habitat of claim 1, wherein the frame includes a removable holding tank.

9. The fish trap habitat of claim 1, wherein the portals comprise conical passageways extending into the fish trap enclosure.

10. The fish trap habitat of claim 1, including an artificial reef within the fish trap enclosure.

11. The fish trap habitat of claim 1, including a gate formed in the screen of sufficient size to allow a human diver to enter into the fish trap enclosure.

12. The fish trap habitat of claim 1, wherein the fish trap enclosure includes a structural framework forming a multi-level structure.

13. The fish trap habitat of claim 12, wherein the structural framework is at least partially surrounded by an artificial reef.

14. The fish trap habitat of claim 12, wherein the structural framework includes doors formed in the structural framework to allow entry of human divers into the multi-level structure.

15. The fish trap habitat of claim 14, wherein the structural framework includes passageways between the multiple levels, and fish trap enclosures for fish and sea creatures.

16. A fish trap habitat, comprising:
a three-dimensional frame of interconnected frame members including a base and hollow members extending upwardly from the base and in fluid communication with the base;
a screen attached to the frame to create a fish trap enclosure within the frame;
conical portals formed through and extending into the fish trap enclosure and configured to allow fish and sea creatures of a predetermined size to enter into the fish trap enclosure from outside of the fish trap habitat while prohibiting fish and sea creatures of a predetermined size from exiting the fish trap habitat; and
means for raising and lowering the fish trap habitat including a pressurized air supply connected to the frame and capable of injecting pressurized air into the hollow members and the base of the frame.

17. The fish trap habitat of claim 16, wherein the means for raising and lowering includes a hollow cable fluidly connected to the frame and capable of injecting pressurized air into the hollow members and base of the frame.

18. The fish trap habitat of claim 16, wherein the means for raising and lowering includes a propulsion system attached to the fish trap habitat, the propulsion system including a propeller, a rudder and a receiver for receiving propulsion instructions from a remotely controlled transmitter.

19. The fish trap habitat of claim 16, wherein the base is configured to accept wheels for travel on dry land.

20. The fish trap habitat of claim 16, wherein the base includes a removable holding tank.

21. The fish trap habitat of claim 16, wherein the base includes a pontoon.

22. The fish trap habitat of claim 16, including an artificial reef within the fish trap enclosure.

23. A fish trap habitat, comprising:
a three-dimensional frame of interconnected frame members;
a screen attached to the frame to form a fish trap enclosure;
portals formed through the fish trap enclosure and configured to allow fish and sea creatures of a predetermined size to enter into the fish trap enclosure from outside of the fish trap habitat while prohibiting fish and sea creatures of a predetermined size from exiting the fish trap habitat;
a gate formed through the screen of sufficient size to allow a human diver to enter the fish trap enclosure; and
a structural framework forming a multi-level structure placed within the fish trap enclosure.

24. The fish trap habitat of claim 23, wherein the structural framework is at least partially surrounded by an artificial reef.

25. The fish trap habitat of claim 23, wherein the structural framework includes doors formed in the structural framework to allow entry of human divers into the multi-level structure.

26. The fish trap habitat of claim 25, wherein the structural framework includes passageways between the multiple levels, and fish trap enclosures for fish and sea creatures.

27. The fish trap habitat of claim 23, wherein the portals comprise conical passageways extending into the fish trap enclosure.

28. The fish trap habitat of claim 23, including means for raising and lowering the fish trap enclosure.

29. The fish trap habitat of claim 28, wherein the frame includes a base fluidly connected to hollow members extending upwardly from the base and the means for raising and lowering includes a hollow cable fluidly connected to the frame and capable of injecting air into the hollow members and the base of the frame.
